(19) United States
(12) Patent Application Publication
(10) Pub. No.: US 2010/0306654 A1
(43) Pub. Date: Dec. 2, 2010

(54) Navigation and Playback of Multimedia Programs Arranged in Collections

(76) Inventors: Pierre-Anthony Stivell Lemieux, San Mateo, CA (US); Oren Micah Williams, San Francisco, CA (US)

Correspondence Address: GIRARD & EQUITZ LLP, 1539 Taraval St., SUITE 202, SAN FRANCISCO, CA, 94116, US

(21) Appl. No.: 12/723,754

(22) Filed: Mar. 15, 2010

Related U.S. Application Data
(60) Provisional application No. 61/181,480, filed on May 27, 2009.

(51) Int. Cl. G06F 3/01

(52) U.S. Cl. 715/716

(57) ABSTRACT

Methods and systems for the navigation and playback of multimedia programs arranged in collections. In typical embodiments, a first set of user controls allow the user to select a collection and a second set of user controls allow the user to select a multimedia program by navigating a sequence of multimedia programs within the selected collection.

### BACKGROUND

Video-on-demand (“VOD”) is becoming an integral part of the entertainment landscape. As opposed to television broadcasting systems, where the same program is transmitted to a large number of viewers according to a set schedule, VOD enables each viewer to select, at any given time, the specific program she wishes to watch. There is currently no straightforward means for easily navigating a complex VOD program catalogs consisting of hundreds and perhaps tens of thousands of individual programs.

In a typical television broadcast system, analog or digital, programming is arranged in a sequence of channels. This arrangement is a legacy of traditional systems where the sequence of channels corresponds to a sequence of non-overlapping frequency ranges within the electromagnetic spectrum. Users may navigate this sequence in its entirety by using the channel-up and channel-down buttons on a remote control, corresponding to tuning an electronic circuit to select the required frequency range in a traditional system.

This simple navigation method is not appropriate for VOD systems, where programs are not arranged in a simple sequence or correspond to ranges of electromagnetic frequencies, but are instead arranged in hierarchical collections. A collection may correspond, for instance, to all episodes of a particular TV show or to all shows produced by NBC Universal.

In a typical VOD system or VOD-like system such as a personal video recorder (PVR) or Internet websites offering video content, the user must navigate a series of menus in order to select a program for viewing, i.e. perform a series of actions such as “navigate, select, play, stop, navigate, select, play, etc.” Such system is substantially more complex than a typical television broadcast system where the user may scan the entire available programming using only two buttons as discussed above. It also requires the user to interrupt her viewing experience in order to make a selection. It also forces the user to re-navigate the menus whenever she wishes to play new content, i.e. it has no memory of the user's navigation history.

### SUMMARY OF THE INVENTION

The invention improves over existing navigation techniques. In typical embodiments, it enables navigation of collections of multimedia programs with minimal user action and with minimal interruption to the viewing experience. In typical embodiments, it simplifies the “navigate, select, play, stop, navigate, select, play . . . ” sequence of actions typically found in VOD and VOD-like systems.

The term “multimedia program” is used herein in the broad sense to mean a combination of one or more of pictures, videos, textual or audio elements, and includes movies, TV programs, advertisements, music videos, songs, etc. The term collection is similarly used in the broad sense to mean a set of multimedia programs that may itself contain other sets of multimedia programs in a hierarchical fashion. For instance, TV episodes may be organized into a single season collection, and multiple seasons collected into a single box-set collection.

As described in the following section, the invention can be implemented in numerous ways, including using a graphical user interface (GUI) on a personal computer or on a remote control in conjunction with a television. In one such implementation, the invention allows a user to navigate individual episodes of TV shows on her TV using a remote control. The remote control includes two sets of two buttons, each set consisting of two buttons, expanding on the traditional TV channel-up and channel-down remote control buttons. The first set of two buttons allows the user to move forward and backward, respectively, across a sequence of TV shows. The sequence may be determined, for instance, by the provider of content, chronological order or an order set by the user. The second set of two buttons allows the user to move forward and backward, respectively, through episodes for the selected TV show. The order of episodes may be determined in any number of ways, similarly to the order of TV shows. The invention also remembers the last selected episode within each TV show, allowing the invention to re-select the episode when the user re-selects the TV show at a later time. The invention automatically displays the episode upon its selection, i.e. by pressing either set of buttons. The invention thereby allows the user to quickly navigate through the collection with simple button presses, without the need to stop playback and navigate a hierarchical menu.

### BRIEF DESCRIPTION OF THE FIGURES

FIG. 1 is a diagram illustrating navigation among episodes of two TV shows, each of the shows consisting of a sequence of episodes.

FIG. 2 is a diagram illustrating navigation among episodes of three TV shows in two channels. Each of the shows consists of a sequence of episodes. Each of the channels consists of at least one of the shows.

FIG. 3 is a block diagram of a system which can implement an embodiment of the invention.

FIG. 4 is a block diagram of an embodiment of the inventive system including a display device (5) and a remote control device (6) including buttons. The buttons can be actuated to perform an embodiment of the inventive method.

FIG. 5 is a block diagram of an embodiment of the inventive system including a processor (8) programmed in accordance with an embodiment of the invention, and a display device (10) and an input device (9) coupled to the processor. In operation, user-selected episodes are displayed in a main display area (or deleted from a set of episodes available for display) in response to user selection (using the input device) of controls (e.g., virtual buttons) displayed above the main display area.

### DETAILED DESCRIPTION

The invention relates to methods and systems for navigating multimedia programs arranged in collections.

### Operation

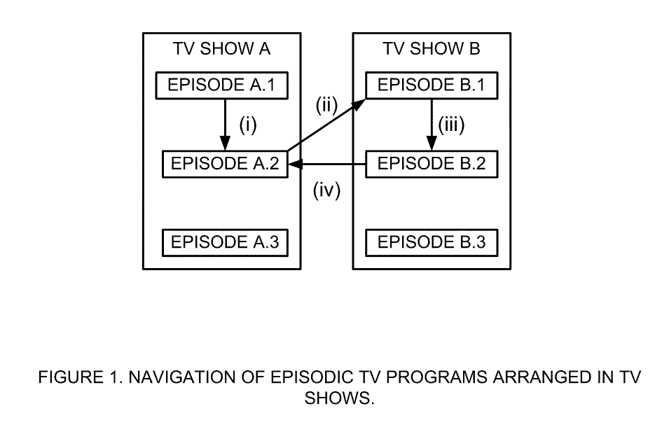

In one application, to be described with reference to FIG. 1, an embodiment of the system is used to navigate episodic TV programs consisting of episodes (multimedia programs), each associated with a TV show (a collection). Within each show, episodes are arranged in a circular sequence in such a way that the episode following the last is the first, and vice and versa. The collections are similarly arranged in a circular sequence. The contents and the order of these sequences may be determined in any number of ways, including by the user, by the content provider, etc.

The system is initialized with a particular episode (A.1) within a particular TV show (A) determined as an initial episode. This initial episode may, for instance, correspond to the last selection made before the system was last turned off, or to a TV show recently added to the system, etc. Similarly the initial episode may correspond to the last episode selected (by a user) within the TV show last selected (by the user). Of course, when the system is used for the first time, the system determines the initial episode to be displayed in some way other than as an episode previously selected by a user. In typical embodiments, playback of the initial episode (A.1) starts automatically upon commencement of operation of the system (without user selection of any episode) either immediately or after some short amount of time, allowing the viewer to get oriented, or select another episode, etc. Optionally, when the system is configured to display episodes from any of a number of collections, each such collection including episodes, playback of an initial episode of a collection starts automatically upon selection of the collection (e.g., the initial episode can be the last episode of the collection that was displayed during the most recent system use session in which at least one episode of the collection was displayed).

At any time, the user may instruct the system to select the next episode (A.2) in TV show (A) or the previous episode (A.3) in sequence of episodes within TV show (A). Assuming the user instructs the system to display the next episode (transition [i] to episode A.2), the system selects episode (A.2), begins playback of episode (A.2) and saves episode (A.2) as the last selected episode. The order of these operations is important: playback may begin even though the process of saving the episode may require some time, e.g., it is saved on a server on the Internet.

At any time, the user may instruct the system to select to the next TV show (B) or the previous TV show (C) in the sequence. In the case where the user instructs the system to select the next show (transition [ii] to TV show B), the system selects TV show (B). It then recalls, selects and begins playback of the episode last selected within TV show (B). If no last episode is associated with TV show (B), e.g. this TV show was never visited by the user, then the system may select an episode using any number of approaches, e.g., the most recent episode, the first episode in alphabetical order, etc.

The user then instructs the system to select episode (B.2). The system selects, begins playback of and saves episodes (B.2). The user then instructs the system to return to the previous TV show (A). The system selects TV show (A), and recalls, selects and begins playback of the episode last selected within TV show (A), namely episode (A.2). The user can therefore jump from TV show to TV show, knowing that upon returning to a previously selected TV show, the episode she was last watching will be automatically selected. This allows the user to effortlessly browse available episodes without navigating complex menus.

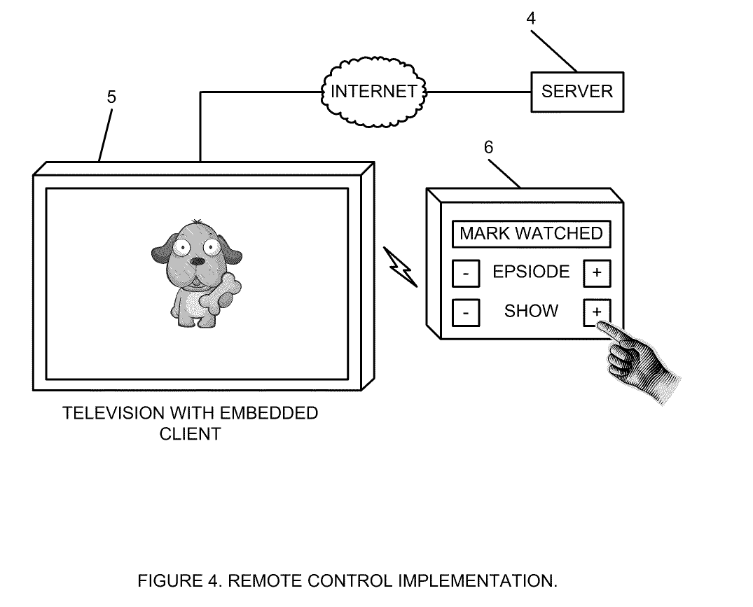

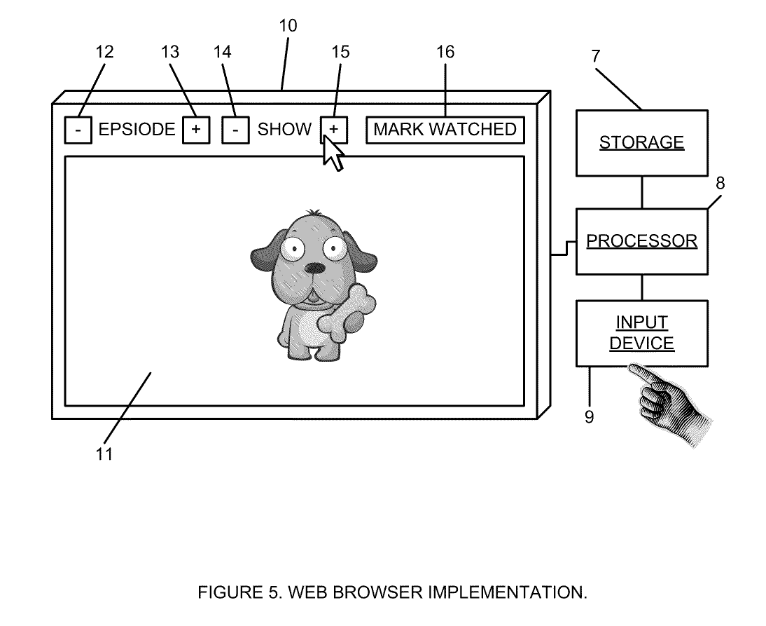

At any time, the user may instruct the system to label the current episode as “watched” (e.g., by selecting the “mark watched” button of remote control 6 in the FIG. 4 system, or the “mark watched” control displayed by the FIG. 5 system). This causes the system to remove the episode from the collection, thereby facilitating navigation by hiding from the user episodes that she has already watched. An episode thus labeled “watched” may nevertheless be accessed through other user interactions. The system may also automatically label a TV show as “watched” when the user watches it in its entirety.

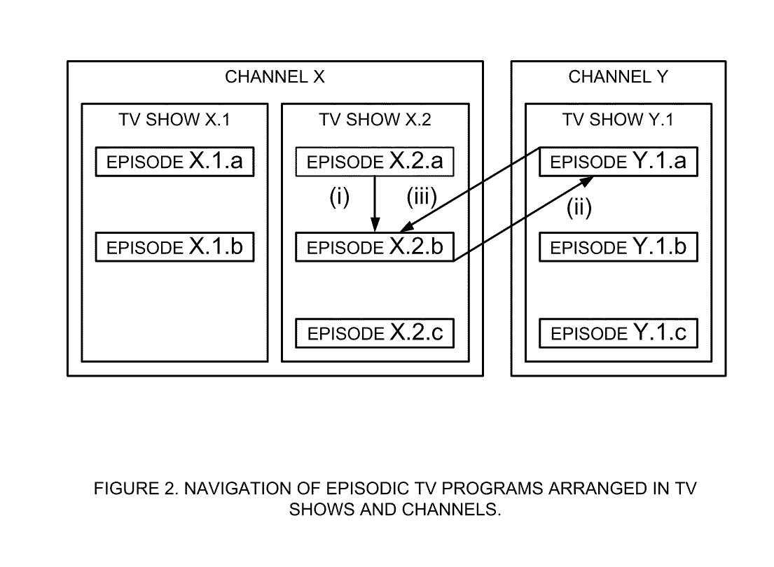

The previous discussion considered a scenario in which episodes are arranged into TV shows, i.e. a two-level hierarchy. The system may be extended to more complex hierarchies. One such complex hierarchy is depicted in FIG. 2. In this hierarchy, TV shows are further collected into channels. As before, the user may instruct the system to select the preceding or following episodes within a TV show, as exemplified by transition (i) from episode X.2.a to episode X.2.b. Similarly, the user may instruct the system to select the preceding or following TV shows, as exemplified by transition (ii) from episode X.2.b to episode Y.1.a. In both cases, the system remembers the last selected episode within each TV show, the last selected TV show within each channel collection and the last selected channel. Hence, as exemplified by transition (iii), if the user instructs the system to move back to channel (X), assuming that episode Y.1.a is selected, the system will automatically select episode X.2.b.

The discussions so far have focused on scenarios where multimedia programs correspond to episodes and collections to TV shows and channels. The system may be extended to other applications where it is desirable to navigate and view multimedia programs arranged in hierarchical structures. The system may for instance be applied to Real Simple Syndication (RSS) feeds, a popular means for publishing sequences of textual, audio and video elements on the Internet. An RSS feed (the collection) consists of individual entries (the multimedia programs) meant to be displayed to the user in sequence.

### Sample Implementations

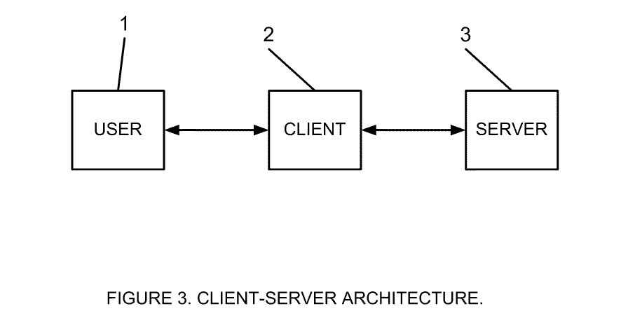

The inventive system can be implemented in variety of ways. One such implementation consists of server and client components, which are depicted in FIG. 3. For example, server 3 of FIG. 3 may be a computer system located remotely from user 1, which is accessible by the user via the Internet and which stores the multimedia content and user navigation history to be accessed in accordance with the invention. Client 2 of FIG. 3 may be a computer system (at the location of user 1) which is programmed with a web browser and (in accordance with the invention) with web application software (e.g., JavaScript code) implementing a user interface which allows the user to manipulate an input device (of the client) to select programs stored in the server for display by the client. Alternatively, client 2 may be some other device or system (e.g., a system including a television configured in accordance with the invention to access content from a remote server and to implement a user interface that allows the user to select the content to be accessed in accordance with the invention, and a user-actuatable remote control device for controlling the television. The remote control device may include user-actuatable buttons such as those shown in FIG. 4 on remote control 6 of FIG. 4).

In typical embodiments of the inventive system having that FIG. 3 architecture, the client component is primarily responsible for processing user input, retrieving and displaying the selected multimedia program, and transmitting to the server the last selected multimedia program. The server component maintains available multimedia programs and collections, and other persistent information such the last selected multimedia program. Both the client and server components may also interact with external entities, including by retrieving multimedia programs.

The client and server components shown in FIG. 3 are logical components that may be implemented in a wide range of devices, and may be in fact implemented on the same device. The client and server components communicate using specified messages, which may be transmitted over networks such as the Internet using protocols such as HTTP. The advantages of such client-server architecture are numerous. This architecture allows, for instance, information, e.g. user preferences and available programming, to be stored once on the server component and accessed from multiple clients in potentially different locations. It also allows, for instance, the client to be ported to a variety of devices without requiring modification to the server implementation, and vice versa.

As depicted in FIG. 4, one such implementation allows a user to navigate and view episodic TV content on a television 5 (or other display device) using a remote control 6 which is coupled to television 5 (e.g., by a wireless link another link) and configured to control display of the content on television 5. Upon initialization, the client component (embedded in the firmware of the television) retrieves from a server component (implemented on a server 4 anywhere on the Internet) information on available multimedia programs and collections. This information may include descriptive titles for the multimedia element as well as instructions, e.g. in the form of a Uniform Resource Locator (URL), to retrieve the multimedia program. The user may then navigate the multimedia elements using a remote control, which transmits commands to the client implementation. Remote control 6 includes buttons labeled “show +”, “show −”, “episode−” and “episode+” (see FIG. 4). These buttons instruct the system to, respectively, select the next TV show, previous TV show, previous episode and next episode. An additional button labeled “mark watched” instructs the system to remove the selected episode from the sequence of episodes in the selected TV show. Upon receiving these commands, the client selects the appropriate episode and TV show, retrieves the selected episode, e.g. from an external entity using the aforementioned URL, and displays the selected episode on the TV display. The client then stores the currently selected episode and TV shows on the server.

In another implementation, the client may be implemented on a web browser running on a personal computer, or mobile device, etc. An example of such an implementation is shown in FIG. 5. Processor 8 of FIG. 5 is programmed to implement a user interface which can provide the display shown (in FIG. 5) on the display device 10 coupled thereto. In operation, user-selected episodes are displayed in a main display area 11 in response to user selection (using input device 9 shown coupled to processor 8) of virtual buttons (user interface elements 12, 13, 14, 15, and 16) displayed above the main display area. Alternatively, the virtual buttons are displayed below or beside the main display area. The virtual buttons (each labeled “−,” “+,” or “mark watch”) correspond to (and have the same functions, respectively, as) the physical buttons on remote control 6 of FIG. 4. Optionally also, the user interface is implemented so that the legend “episode” (between the left pair of virtual buttons 12 and 13) is itself a virtual control that, when clicked on by the user (using input device 9), causes display of a conventional hierarchical “tree” or “outline” menu of episodes available for selection by the user (e.g., by clicking conventionally on icons of the hierarchical menu). Optionally also, the user interface is implemented so that the legend “show” (between the right pair of virtual buttons 14 and 15) is itself another virtual control that, when clicked on by the user, causes display of a conventional hierarchical “tree” or “outline” menu of shows (and/or episodes thereof) whose episodes are available for selection by the user (e.g., by clicking conventionally on icons of the hierarchical menu).

Preferably, the FIG. 5 system is implemented to start playback of an initial episode automatically upon commencement of operation of the system (without user selection of any episode) either immediately or after some short amount of time. The initial episode is preferably the episode last viewed by the user during the most recent previous system use session. Also preferably, in response to each user actuation of the input device to select one of the virtual buttons “−” and “+,” the system automatically starts to play the selected episode in the main display area (without the need for any additional user actuation of the input device). Also preferably, the FIG. 5 system is implemented to start playback of each selected episode automatically at the location (within the episode) at which the system ceased to display the episode during the most recent display by the system of the episode. Also preferably, the FIG. 5 system is implemented so that user selection of the “mark watched” virtual button causes the episode currently being displayed to be deleted from the set of episodes available for display in response to user selection (using the input device) of the virtual buttons “−” and “+,” but nevertheless accessible through the aforementioned “show” and “episode” virtual controls. Also preferably, the system is implemented so that, upon the user selecting labeling an episode as “watched”, the system automatically selects the next show (or alternatively the previous show) in the sequence if no episode is available in the currently selected show. Also preferably, the system is implemented so that, upon the user selecting a next (previous) show, the system automatically skips shows for which no episodes are available.

In general, the user interacts with the FIG. 5 system using an input device 9 (e.g. a mouse or multi-touch screen) connected to an appropriately programmed central processing unit (or other programmed processor) 8, itself connected to a storage unit 7 and to a display unit 10. In implementations of this type, user interface elements (e.g., those depicted in FIG. 5) displayed on the screen of the display unit replace physical remote control buttons (e.g., those described with reference to FIG. 4).

Storage unit 7 depicted in FIG. 5 is preferably a device located remotely from processor 8 (which may be a central processing unit), which is accessible by processor 8 via a network and which stores multimedia content and user navigation history to be accessed in accordance with the invention (e.g., as does server 4 described earlier in connection with FIG. 4). Storage unit 7 may optionally be a device located in proximity to processor 8.

While specific embodiments of the invention and applications of the invention have been described herein, it will be apparent to those of ordinary skill in the art that many variations on the embodiments and applications described herein are possible without departing from the scope of the invention described and claimed herein. It should be understood that while certain forms of the invention have been shown and described, the invention is not to be limited to the specific embodiments described and shown or the specific methods described.

1. A system for navigating multimedia programs arranged in collections, comprising:
a means for selecting one of a next and a previous collection in a sequence of collections; and
a means for selecting one of a next and a previous multimedia program in a sequence of multimedia programs within a currently selected collection; and
a means for memorizing the last multimedia program selected within a collection and automatically selecting said multimedia program upon selecting said collection; and
a means for displaying to a user a multimedia program upon its selection.

2. The system of claim 1, wherein the sequence of collections and each said sequence of multimedia programs are determined by the user.

3. The system of claim 1, wherein the sequence of collections and each said sequence of multimedia programs are predetermined.

4. The system of claim 1, also including:
a means for removing a multimedia program from one of the collections; and
a means for adding a multimedia program to one of the collections.

5. The system of claim 1, wherein the means for displaying is a display device, the system includes a remote control coupled and configured to control display of the multimedia programs by the display device, the means for selecting one of a next and a previous collection includes at least one button on the remote control, and the means for selecting one of a next and a previous multimedia program includes at least one other button on the remote control.

6. The system of claim 5, wherein the means for selecting one of a next and a previous collection includes a first button of the remote control for selecting a next collection and a second button of the remote control for selecting a previous collection, and the means for selecting one of a next and a previous multimedia program includes a third button of the remote control for selecting a next multimedia program and a fourth button of the remote control for selecting a previous multimedia program.

7. The system of claim 1, wherein the means for displaying is a display device, the system includes a processor coupled to the display device and configured to control display of the multimedia programs by the display device, the processor is programmed to implement a user interface which displays user interface elements on the display device, the means for selecting one of a next and a previous collection includes at least one of the user interface elements, and the means for selecting one of a next and a previous multimedia program includes at least one other one of the user interface elements.

8. The system of claim 1, wherein the multimedia programs correspond to TV show episodes and each of the collections corresponds to a collection of TV show episodes.

9. The system of claim 1, wherein the multimedia programs correspond to RSS feed entries and each of the collections corresponds to an RSS feed.

10. The system of claim 1, including an end-user device and a storage device distinct from the end-user device, wherein the end-user device is configured to provide each said means for selecting, the means for memorizing, and the means for displaying, and wherein information determining the last multimedia selected is stored in the storage device.

11. The system of claim 1, wherein each said sequence is a circular list of elements, whereby the one of the elements following the last one of the elements of the sequence is the first one of the elements of the sequence, and the one of the elements preceding the first one of the elements of the sequence is the last one of the elements of the sequence.

12. The system of claim 1, wherein collections containing no multimedia programs are not included in the sequence of collections.

13. The system of claim 1, also including: a means for memorizing the last selected collection and automatically selecting said collection upon commencement of operation of the system.

14. A method for navigating multimedia programs arranged in collections, including the steps of:
(a) simultaneously providing a set of controls such that all the controls are simultaneously available to a user in the sense that any of the controls is actuatable by the user at an instant of time, wherein the set of controls includes at least a first subset of the controls and a second subset of the controls, and such that user actuation of any control in the first subset results in selection of one of a next and a previous collection in a sequence of the collections and user actuation of any control in the second subset results in selection of one of a next and a previous multimedia program of a currently selected one of the collections; and
(b) displaying to the user a multimedia program upon its selection.

15. The method of claim 14, also including the step of memorizing the last multimedia program selected within one of the collections and automatically selecting said multimedia program upon selecting said one of the collections.

16. The method of claim 15, also including the step of memorizing the last selected collection and automatically selecting said collection upon commencement of operation of the system.

17. The method of claim 14, wherein step (a) includes the step of simultaneously displaying the controls on a display device.

18. The method of claim 17, wherein step (b) includes the step of displaying the multimedia program in a main display area of the display device, step (a) includes the steps of displaying the controls other than in the main display area of the display device, the first subset of the controls includes a next program selection control and a previous program selection control, and the second subset of the controls includes a next collection selection control and a previous collection selection control.

19. The method of claim 14, wherein the controls are user-actuatable buttons on a remote control device, the first subset of the controls includes a next program selection button and a previous program selection button, and the second subset of the controls includes a next collection selection button and a previous collection selection button.

20. The method of claim 14, wherein the sequence of multimedia programs and collections is determined by the user.

21. The method of claim 14, wherein the sequence of multimedia programs and collections is determined by the creator of the collection.

22. The method of claim 14, wherein the set of controls also includes a deletion control, and actuation of the deletion control results in removing a multimedia program from a collection.

23. The method of claim 14, wherein the first subset of the controls and the second subset of the controls are implemented as buttons on a remote control.

24. The method of claim 23, wherein the first subset of the controls includes a single button for selecting the next collection and a single button for selecting the previous collection, and the second subset of the controls includes a single button for selecting the next multimedia program and a single button for selecting the previous multimedia program.

25. The method of claim 14, wherein step (a) includes the steps of displaying the controls as user interface elements.

26. The method of claim 14, wherein the multimedia programs correspond to TV show episodes and the collection corresponds to a collection of TV show episodes.

27. The method of claim 14, wherein the multimedia programs correspond to RSS feed entries and the collection corresponds to an RSS feed.

28. The method of claim 14, wherein steps (a) and (b) are performed by operating an end-user device, and also including the step of storing information determining the last multimedia selected in device distinct from the end-user device.

29. The method of claim 14, wherein each said sequence is a circular list of elements, whereby the one of the elements following the last one of the elements of the sequence is the first one of the elements of the sequence, and the one of the elements preceding the first one of the elements of the sequence is the last one of the elements of the sequence.

30. The method of claim 14, wherein collections containing no multimedia programs are not included in the sequence of collections.

31. A system for navigating multimedia programs arranged in collections, including:
a set of controls, wherein all the controls are simultaneously available to a user in the sense that any of the controls is actuatable by the user at an instant of time, the set of controls includes at least a first subset of the controls and a second subset of the controls; and
a processor operable in response to the set of controls, such that the processor selects and initiates playback of one of a next and a previous collection in a sequence of the collections in response to user actuation of any control in the first subset, and the processor selects and initiates playback of one of a next and a previous multimedia program of a currently selected one of the collections in response to user actuation of any control in the second subset.

32. The system of claim 30, wherein the processor is configured to memorize the last multimedia program selected within one of the collections and to select automatically said memorized multimedia program upon selecting said one of the collections.

33. The system of claim 30, including a display device coupled to the processor and an input device coupled to the processor, wherein the processor is configured to implement a user interface in which the controls are simultaneously displayed on the display device, and the processor recognizes user selection of any one of the controls using the input device as user actuation of said one of the controls.

34. The system of claim 33, including a display device coupled to the processor and a remote control device, wherein the controls are user-actuatable buttons on the remote control device, the first subset of the controls includes a next program selection button and a previous program selection button, and the second subset of the controls includes a next collection selection button and a previous collection selection button.
